(19) United States
(12) Patent Application Publication
(10) Pub. No.: US 2010/0142427 A1
(43) Pub. Date: Jun. 10, 2010

(54) Mobile Wireless Internet System

(76) Inventor: Roger Ramsey, Wellsville, NY (US)

Correspondence Address: L.C. Begin & Associates, PLLC, 510 Highland Avenue, PMB 403, Milford, MI, 48381, US

(21) Appl. No.: 12/634,167

(22) Filed: Dec. 9, 2009

Related U.S. Application Data
(60) Provisional application No. 61/120,910, filed on Dec. 9, 2008.

(51) Int. Cl. G08C 17/00

(52) U.S. Cl. 370/311

(57) ABSTRACT

A mobile wireless internet system is provided. The mobile wireless internet system may include a primary power assembly capable of converting solar energy into electrical energy. Further, the mobile wireless internet system may include a communication assembly capable of receiving wireless signals from an internet service provider. The primary power assembly may be capable of providing the electrical energy to the communication assembly. Furthermore, the mobile wireless internet system may include at least one communication antenna operatively coupled to the communication assembly. The at least one communication antenna may be capable of receiving the wireless signals from the communication assembly and transmitting the received wireless signals to at least one user terminal. Also, the mobile wireless internet system may include a platform. The platform may be capable of being removably engaged with an automobile to be transported to a desired location.

### CROSS REFERENCE TO RELATED APPLICATION

This application claims the benefit of U.S. Provisional Application No. 61/120,910 filed on Dec. 9, 2008, the disclosure of which is incorporated by reference.

### FIELD OF THE INVENTION

The present disclosure generally relates to internet systems, and more particularly, to a self-powered mobile wireless internet system capable of being transported to remote locations for providing internet services.

### BACKGROUND OF THE INVENTION

The Internet has been widely used for connecting various computer systems across the globe. Specifically, various electronic signal transmission media, such as telephone lines, optical fibers, satellite systems, and the like, may be employed for sending and receiving information through the interne. Considering the benefits associated with the use of internet, even people in remote locations feel a desire to access internet services.

However, in common occurrence, many individuals in remote locations encounter problems in accessing an internet network. Such problems may arise due to unavailability of appropriate electronic media, inaccessibility of power outlets and/or appropriate data transmission devices. Also, conventional internet access systems may be installed at specific sites in remote locations as where the demand for internet services is moderate or low. However, installation of the conventional internet systems at such specific sites is associated with high cost incurred due to complexity involved in installation of the various hardware, software, and firmware components of the conventional internet systems. Further, deficient supply of electricity in the remote locations may deter internet service providers from installing the conventional internet systems in the remote locations, as the internet service providers fear loss of business due to an interrupted supply of electricity. Furthermore, it has been observed that even in areas such as cities and towns with relatively high demand for internet services, the interne service gets interrupted or terminated when the supply of electricity gets disrupted for various reasons, such as during emergency situations and/or natural calamities. In such situations, unavailability of uninterrupted internet service may prove to be discomfort for people using the internet service.

### SUMMARY OF THE INVENTION

One embodiment of a mobile wireless internet system is provided. The mobile wireless internet system may include a primary power assembly capable of converting solar energy into electrical energy. Further, the mobile wireless internet system may include a communication assembly capable of receiving wireless signals from an internet service provider. The primary power assembly may be capable of providing the electrical energy to the communication assembly. Furthermore, the mobile wireless internet system may include at least one communication antenna operatively coupled to the communication assembly. The at least one communication antenna may be capable of receiving the wireless signals from the communication assembly and transmitting the received wireless signals to at least one user terminal. Also, the mobile wireless internet system may include a platform adapted to carry the primary power assembly, the communication assembly and the at least one communication antenna. The platform may be capable of being removably engaged with an automobile to be transported to a desired location.

### BRIEF DESCRIPTION OF THE DRAWINGS

These and other features and advantages of the present disclosure will be apparent from the following detailed description of preferred embodiments and best mode, appended claims, and accompanying drawings in which:

FIG. 1 is a block diagram of an embodiment of a mobile wireless internet system interacting with an internet service provider and a user terminal;

FIG. 2 is a block diagram of a primary power assembly of the mobile wireless internet system of FIG. 1;

FIG. 3 is a block diagram of a communication assembly of the mobile wireless internet system of FIG. 1; and

FIG. 4 is a perspective view of the mobile wireless internet system of FIG. 1.

Like reference numerals refer to like parts throughout the description of several views of the drawings.

### DETAILED DESCRIPTION

The exemplary embodiments described herein provide detail for illustrative purposes and are subject to many variations in structure and design. It should be emphasized, however, that the present disclosure is not limited to a particular mobile wireless internet system, as shown and described. It is understood that various omissions and substitutions of equivalents are contemplated as circumstances may suggest or render expedient, but these are intended to cover the application or embodiment without departing from the spirit or scope of the claims of the present disclosure. Also, it is to be understood that the phraseology and terminology used herein are for the purpose of description and should not be regarded as limiting.

The use of “including,” “comprising,” or “having” and variations thereof herein is meant to encompass the items listed thereafter and equivalents thereof as well as additional items. Further, the terms “a” and “an” herein do not denote a limitation of quantity, but rather denote the presence of at least one of the referenced item.

The present disclosure provides a mobile wireless internet system capable of being readily moved to remote locations for providing internet services. As used herein, the term “internet” is understood to mean a system comprising a worldwide network of constituent computer networks that use common communications protocols (such as TCP/IP network protocols) to facilitate data transmission and exchange.

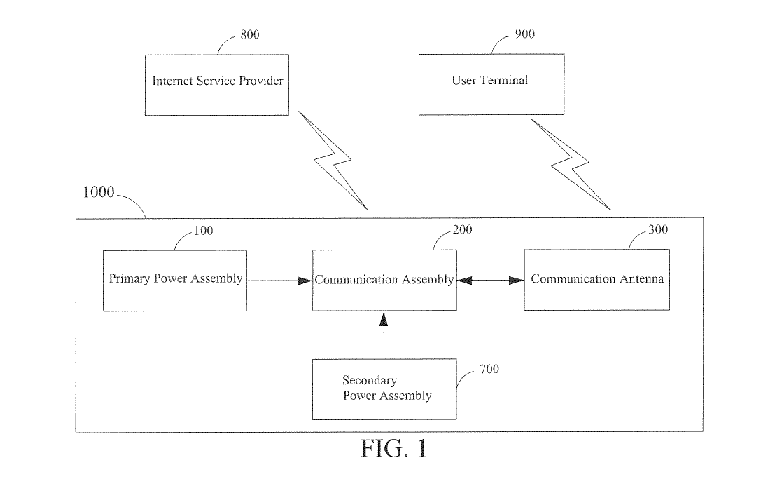

Referring to FIGS. 1 to 4, one embodiment of a mobile wireless internet system 1000 is shown, that may be capable of receiving wireless signals from an internet service provider 800 and transmitting the received wireless signals to at least one user terminal, such as a user terminal 900, at remote locations. The system is also configured for conveying signals to and/or receiving signals from (via a transmission line or other signal transmission medium) the user terminal 900 and transmitting the received signals to the internet service provider 800.

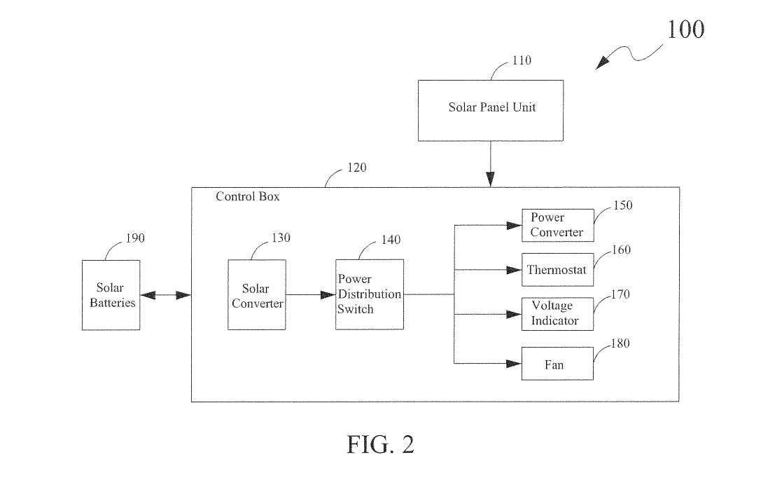

In the embodiment shown in FIG. 1 the system 1000 includes a primary power assembly 100 capable of supplying the power requirements of the system 1000. In one particular embodiment, the power assembly is capable of converting solar energy into electrical energy. In this particular embodiment, the primary power assembly 100 may include at least one solar panel unit, such as a solar panel unit 110 (as shown in FIG. 2). The solar panel unit 110 may include an array of photovoltaic panels or cells (not shown). One manufacturer of solar panels suitable for the applications described herein is Online Solar, Inc. of Hunt Valley, Md.

Further, the primary power assembly 100 may include a control box 120 operatively coupled to the solar panel unit 110. The control box 120 may be an environmentally secure container, which is waterproof and temperature-controlled to prevent overheating of the components positioned in the control box. The control box 120 may house a plurality of operating devices such as a solar controller or converter 130, a known power distribution switch 140, at least one known power converter such as a power converter 150, a thermostat 160, a voltage indicator 170, at least one cooling member such as a fan 180, and the like. Furthermore, the primary power assembly 100 may include a plurality of solar batteries, such as solar batteries 190 connected in series and operatively coupled to the solar panel unit 110 and the control box 120. In one embodiment, the solar batteries are standard, commercially available 12V sealed lead acid batteries.

In a particular embodiment, an adapter (not shown) operatively coupled to the power distribution switch 140 may be provided. In a particular embodiment, the adapter is a standard car cigarette lighter four-plug adapter. Any component of the present disclosure that may require electrical energy may be connected to the power source with the adapter using a standard cigarette lighter power plug. It will be evident that the primary power assembly 100 may include requisite electrical connections (not shown) and one or more electrical circuits (not shown) for providing operative couplings among the various components, such as the solar panel unit 110, the solar converter 130, the power distribution switch 140, the power converter 150, the thermostat 160, the voltage indicator 170, the fan 180, and the solar batteries 190, of the primary power assembly 100. The required structure of these and any other electrical connections between the elements described herein may readily be determined by one of ordinary skill in the art using information such as the specifications of the various hardware components comprising the system 1000 and other pertinent information. An example of a solar converter suitable for the applications described herein is available from Morningstar Corporation of Newtown, Pa. In addition, suitable electrical circuits or other hardware (such as surge protectors) and/or devices may be provided for suitably grounding the system components and for otherwise protecting the elements and/or sub-assemblies of the system 1000 from overvoltage and overcurrent conditions resulting from lightning strikes, voltage spikes, etc.

It will also be appreciated that types of power sources other than solar-powered sources may be included in the system 100 or may be used to provide power to the system 1000. For example, a commercially available portable generator or other such device may be used to power the system if supplied with suitable electrical connections to the other elements of the system. In a particular embodiment, an engine on a vehicle which transports the system supplies power for the system or for one or more elements of the system via suitable power conversion hardware.

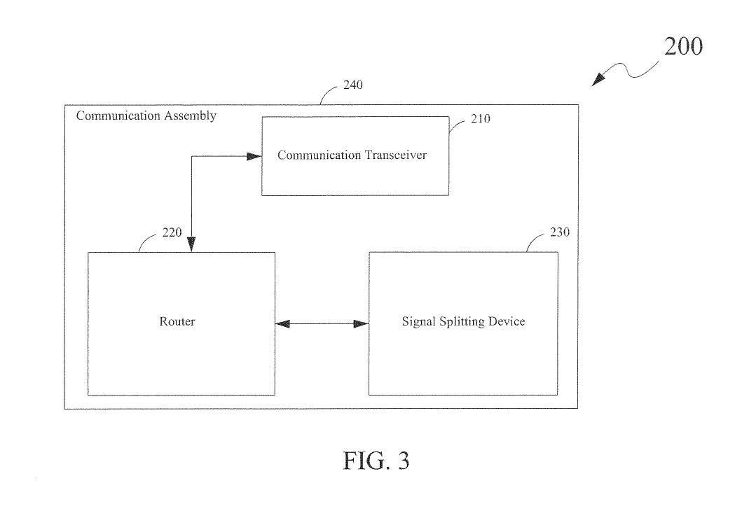

The system 1000 may further include a communication assembly 200 operatively coupled to the primary power assembly 100 (as shown in FIG. 3). The communication assembly 200 may include various communication devices such as a known communication transceiver 210, a known router 220, and a suitable, known signal splitting device 230. The communication assembly 200 may also include a suitable, known cooling member (not shown). Further, the communication transceiver 210, the router 220, the signal splitting device 230, and the cooling member may be housed in a box 240. Further, it will be evident that the communication assembly 200 may include requisite electrical connections (not shown) and one or more electrical circuits (not shown) for providing operative couplings among the various components, such as the communication transceiver 210, the router 220, the signal splitting device 230, and the cooling member, of the communication assembly 200. One example of a router suitable for the applications described herein is the D-Link 3G Mobile Router DIR-450 wireless router, commercially available from a wide variety of sources, for example, Office Depot. One example of a transceiver suitable for the applications described herein is the EOC-2610 600 mW outdoor wireless access point available from EnGenius of Costa Mesa, Calif.

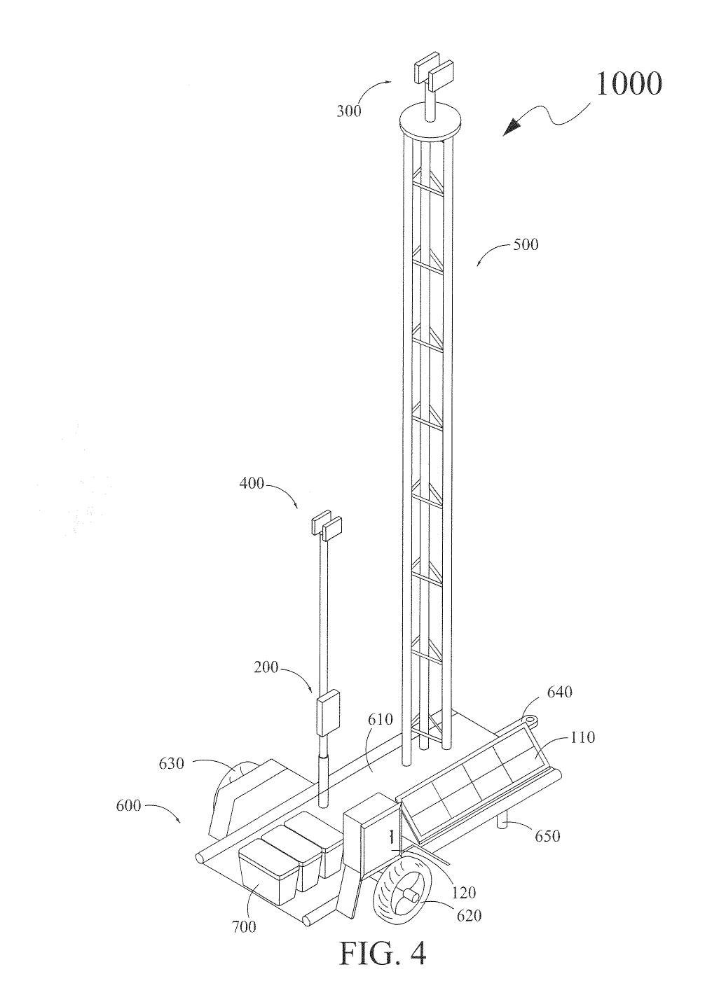

Referring to FIG. 4, the system 1000 may also include at least one communication antenna such as an antenna 300 operatively coupled to the communication assembly 200. The antenna 300 may be a conventional wireless internet antenna, which may be either an omni directional antenna or a directional antenna depending upon a topology. One example of a wireless internet antenna suitable for the applications described herein is the HAO14SDP Hi-Gain Directional 14 Dbi Antenna available from Hawking Technologies, Inc. of Irvine, Calif. In one form, the system 1000 may further include a monopole antenna 400. The specific type of antenna (or antennae) used may be based on the requirements of a particular customer or application.

Further, the system 1000 may include an antenna mast 500 for supporting the antenna 300. In one form, the antenna mast 500 may be a collapsible mast. In other form, the antenna mast 500 may be telescopic mast. The antenna mast 500 may be adapted to be adjusted in a plurality of angles. In one embodiment, the antenna mast is a conventional hand-cranked aluminum ham radio mast. In one embodiment, the antenna mast has one or more 12 v high intensity LED lights mounted at or near the top of the antenna to enhance visibility of the antenna in the deployed position. The lights may be powered by the solar battery system. Other additional lights or visibility-enhancing devices may be employed if desired. In one embodiment, the mast has a built-in hinge allowing it to be lowered and tilted for maintenance and for transportation.

The system 1000 may include a platform 600. The platform 600 may include a base 610 for carrying the solar panel unit 110, the control box 120, the communication assembly 200, the antenna 300, the monopole antenna 400, and the antenna mast 500. Further, it will be evident that the system 1000 may include requisite electrical connections (not shown) and one or more electrical circuits (not shown) for providing operative couplings among the various components, such as the primary power assembly 100, the communication assembly 200, the antenna 300, and the monopole antenna 400. Furthermore, the platform 600 may include at least one pair of wheels 620, 630. Also, the platform 600 may include a first attachment member 640 capable of removably engaging with a complimentary second attachment member 12 of a suitable transportation medium, such as an automobile 10. Other transportation media such as a railroad flatcar, a truck, or other suitable media may also be employed. Additionally, the platform 600 may include at least one foldable supporting member such as a supporting member 650 capable of keeping the base 610 horizontally straight in a stationery position. In one form, the platform 600 may be a trailer capable of being attached to a suitable vehicle of any make.

Further, the system 1000 may include a secondary power assembly 700 operatively coupled to the communication assembly 200. The secondary power assembly 700 may include a power supplying source, such as at least one rechargeable battery (not shown), a suitable generator (not shown), and the like. Alternatively, the power source may include a wind turbine system (not shown) or any other suitable power source. The rechargeable battery may be adapted to store electrical energy received from the solar panel unit 110. The secondary power source may be transported on the platform 600 or on a separate conveyance, for example on the transpiration medium itself.

In use, the primary power assembly 100, the communication assembly 200, the monopole antenna 400, the antenna mast 500, and the secondary power assembly 700 may be configured on the base 610 of the platform 600. The primary power assembly 100, the communication assembly 200, the monopole antenna 400, the antenna mast 500, and the secondary power assembly 700 may be operatively coupled by the requisite electrical connections and one or more electrical circuits. The antenna 300 may be installed on the antenna mast 500. The communication assembly 200 may be directly placed on the base 610. Alternatively, the communication assembly 200 may be detachably suspended on the monopole antenna 400.

The solar panel unit 110 of the primary power supply may be capable of receiving solar energy. The array of photovoltaic cells may then be capable of converting the solar energy into the electrical energy. In an example, the solar panel unit 110 may be capable of producing 24 volt electrical energy. The solar converter 130 may be capable of converting the 24 volt electrical energy into 12 volt electrical energy. Thereafter, the electrical energy may be stored in the solar batteries 190. In one form, the solar batteries 190 may include three solar batteries connected in series. The solar batteries 190 may be operatively coupled to the control box 120. In this manner, if the primary power supply fails to provide energy to the system for an extended period of time (for example, at night in a solar powered system), the batteries 190 can maintain energy flow to the system prior to maintenance of the device. In a particular embodiment, the elements of the system 100 operate on either 12V or 24V power.

The primary power assembly 100 may be capable of providing a constant supply of electrical energy to the communication assembly 200 and also maintaining an optimal environment inside the control box 120. For instance, the power distribution switch 140 may be selectively operated to allow and/or discontinue the supply of the electrical energy to any of the system components.

Further, the electrical energy may be directed to the communication assembly 200. In one form, the adapter operatively coupled to the power distribution switch 140 may be adapted to distribute the electrical energy to every component of the present disclosure that may require the electrical energy. Further, the electrical energy may be received by the power converter 150. In an example, the power converter 150 may be adapted to convert 12 volt electrical energy into 110 volt electrical energy. In one form, two power converters may be employed for providing the electrical energy to the communication assembly 200. Further, maintaining an optimal temperature inside the control box 120 may be required. Cooling may be automatically initiated by the thermostat 160 by triggering the fan 180 to operate, when an internal temperature inside the control box 120 exceeds a predetermined temperature. Also, the voltage indicator 170 may be adapted to provide for measuring the voltage of the electrical energy.

The primary power assembly 100 may be adapted to provide the electrical energy to the communication assembly 200 in order to allow the various communication devices such as the communication transceiver 210, the router 220, the signal splitting device 230, and the cooling member, to operate.

The communication transceiver 210 may be capable of receiving and transmitting wireless signals. The wireless signals may be received from the internet service provider 800. Alternatively, the wireless signals may be received via satellite input. The wireless signals received from the internet service provider 800 may be passed from the communication transceiver 210 to the router 220.

In one particular embodiment, an EVDO device sends and receives wireless signals. The EVDO device also converts the wireless signals into a form usable by the wireless router, and also converts signals received from the router for subsequent transmission by the transceiver.

In a particular embodiment, DNS routing is handled by a router separate from the wireless router. The additional router is incorporated into the system in a suitable manner, as previously described with regard to the other system elements. In this embodiment, the wireless router is focused on receiving and processing the wireless signal. This embodiment may be implemented, for example, when the number of system users exceeds a certain threshold.

In one particular embodiment, the mobile wireless internet system is configured to receive signals from (and transmit signals to) a satellite system. In this embodiment, a satellite modem is employed in place of (or in addition to) the transceiver previously described. In addition, a conventional router is employed in place of (or in addition to) the router previously described.

The router 220 or a separate electronic circuit may be adapted to amplify the wireless signals received from the communication transceiver 210. Thereafter, the wireless signals may be transmitted to the antenna 300 via the signal splitting device 230. The antenna 300 may be capable of transmitting the wireless signals to the at least one user terminal such as the user terminal 900. The user terminal 900 may be a personal computer, a mobile phone, a Personal Digital Assistant (PDA), a laptop, a notebook computer, and the like. The antenna 300 may also be adapted to receive the wireless signals from the user terminal 900.

Furthermore, the secondary power assembly 700 of the system 1000 may also be capable of providing the electrical energy to the communication assembly 200. The secondary power assembly 700 acts as an electrical energy backup in order to keep the communication assembly 200 operational in situations where the primary power assembly 100 may become temporarily inactive due to various reasons, such as bad weather, insufficient sunlight and the like.

Also, the platform 600 may be capable of being transported to remote locations. The first attachment member 640 of the platform 600 may be adapted to removably attach with the second attachment member 12 of the automobile 10 or other transportation medium for moving the system 1000 to the desired location. The base 610 may be moved with the help of the wheels 620, 630. During the transportation of the platform 600, the supporting member 650 may be disposed in a folded manner. On reaching the desired location, the platform 600 may be detached from the automobile 10 or other transportation medium and the base 610 may be horizontally supported with the help of the supporting member 650 and the wheels 620, 630.

The mobile wireless internet system, such as the system 1000, may be beneficial for providing internet service at remote locations. The capability of self generating the electrical energy may be helpful for operation of the various components of the mobile wireless internet system and as such precluding need of an external power supply source. Further, the mobile wireless internet system may be beneficial for providing internet service, where the conventional internet systems become defunct due to various reasons such as during emergency situations and/or natural calamities. Furthermore, the simple structural configuration, portability, and ease-to-use ability makes the mobile wireless internet system capable of being transported and installed to a desired location in a very less time and as such may be very helpful during emergency situations and/or natural calamities.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present disclosure.

What is claimed is:

1. A mobile wireless internet system, comprising:
a communication assembly capable of receiving wireless signals from an internet service provider;
a primary power assembly operatively coupled to the communication assembly for providing the electrical energy to the communication assembly;
at least one communication antenna operatively coupled to the communication assembly, the at least one communication antenna being capable of receiving the wireless signals from the communication assembly and transmitting the received wireless signals to at least one user terminal; and
a platform adapted to carry the primary power assembly, the communication assembly and the at least one communication antenna, the platform capable of being removably engaged with a transportation medium to be transported to a desired location.

2. The mobile wireless internet system of claim 1, further comprising a secondary power assembly operatively coupled to the communication assembly for providing electrical energy backup.

3. The mobile wireless internet system of claim 1, wherein the primary power assembly comprises,
at least one solar panel unit capable of receiving solar energy, the at least one solar panel unit capable of converting the solar energy into the electrical energy,
a plurality of solar batteries operatively coupled to the at least one solar panel unit for receiving the electrical energy, the plurality of solar batteries capable of storing the received electrical energy, and
a control box operatively coupled to the at least one solar panel unit and the plurality of solar batteries.

4. The mobile wireless internet system of claim 1, wherein the primary power assembly comprises a thermostat for regulating temperature inside the control box.

5. The mobile wireless internet system of claim 1, wherein the communication assembly comprises,
a communication transceiver capable of receiving the wireless signals from the internet service provider,
a router operatively coupled to the communication transceiver, the router capable of routing the wireless signals received from the communication transceiver, and
a signal splitting device operatively coupled to the router, the signal splitting device capable of directing the wireless signals from the router to the at least one communication antenna.

6. The mobile wireless internet system of claim 1, further comprising an antenna mast pivotally mounted on the platform, the antenna mast capable of carrying the at least one communication antenna.

7. The mobile wireless internet system of claim 1 wherein the primary power assembly is capable of converting solar energy into electrical energy.

8. The mobile wireless internet system of claim 1 wherein the transportation medium comprises an automobile.

9. The mobile wireless internet system of claim 1 wherein the secondary power assembly is carried by the platform.
